(19) United States
(12) Patent Application Publication
(10) Pub. No.: US 2026/0156338 A1
(43) Pub. Date: Jun. 4, 2026

(54) CAMERA MODULE

(71) Applicant: Samsung Electro-Mechanics Co., Ltd., Suwon-si (KR)

(72) Inventors: Chueljin PARK, Suwon-si (KR); Sanghyun JI, Suwon-si (KR); Dooseub SHIN, Suwon-si (KR)

(73) Assignee: Samsung Electro-Mechanics Co., Ltd., Suwon-si (KR)

(21) Appl. No.: 19/172,623

(22) Filed: Apr. 7, 2025

(30) Foreign Application Priority Data
Nov. 29, 2024 (KR) 10-2024-0174628

(51) Int. Cl. H04N 23/54; G03B 5/00; G03B 30/00; H04N 23/68

(52) U.S. Cl. CPC H04N 23/54; G03B 5/00; G03B 30/00; H04N 23/687; G03B 2205/0007; G03B 2205/0069

(57) ABSTRACT

A camera module is provided. The camera module includes an auto-focus (AF) holder coupled to a circuit board on which an image sensor is disposed, an AF drive part configured to move the AF holder, a lens holder coupled to a lens barrel that is configured to accommodate at least one lens, and an optical image stabilization (OIS) drive part that is configured to move the lens holder.

### CROSS-REFERENCE TO RELATED APPLICATIONS

This application claims the benefit under 35 USC § 119(a) of Korean Patent Application No. 10-2024-0174628 filed on Nov. 29, 2024, in the Korean Intellectual Property Office the entire disclosure of which is incorporated herein by reference for all purposes.

### BACKGROUND

### 1. Field

The following description relates to a camera module.

### 2. Description of Related Art

With the remarkable development of information communication technologies and semiconductor technologies, the use of electronic devices has rapidly increased. These electronic devices may converge various operations and provide the converged operations without remaining in a traditional common region.

Recently, cameras are basically implemented in portable electronic devices such as, but not limited to, tablet personal computers (PCs) and laptop computers as well as smartphones. The camera of the portable electronic device may implement an autofocus (AF) operation, an optical image stabilization (OIS) operation, and a zoom operation.

The autofocus operation refers to an operation that acquires a clear image on an image formation plane of an image sensor by moving a lens, which is positioned forward of the image sensor, in an optical axis direction in accordance with a distance from the subject.

The optical image stabilization operation refers to an operation of moving the lens or the image sensor in a direction perpendicular to the optical axis in order to prevent vibration of an image of a subject, which is to be captured, because of camera swaying, hand shaking, or the like.

As a camera module uses a high-pixel sensor, an optical format of an image sensor becomes large, and a weight of the lens is also increased to suit the optical format. Accordingly, if an autofocus operation or an optical image stabilization operation is performed by moving the lens, the increase in weight of the lens acts as a large load, which causes a deterioration in performance, defective reliability, and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes an auto-focus (AF) holder coupled to a circuit board on which an image sensor is disposed; an AF drive part configured to move the AF holder; a lens holder coupled to a lens barrel configured to accommodate at least one lens; and an optical image stabilization (OIS) drive part configured to move the lens holder.

The camera module may include a housing in which the AF holder, the AF drive part, and the OIS drive part are disposed.

The AF holder may be disposed in an inner opening of the housing.

The AF drive part may include an AF magnet disposed at one side of the AF holder, and an AF coil disposed at one side of the housing opposite to the AF magnet.

The AF holder may include an AF magnet accommodation portion provided at one side of the AF holder, and the AF magnet may be disposed on the AF magnet accommodation portion, and the housing may include an AF coil mounting portion provided at one side of the housing, and the AF coil is disposed on the AF coil mounting portion.

The OIS drive part may include an OIS magnet disposed on a lower portion of the lens holder, and an OIS coil disposed on an upper portion of the housing opposite to the OIS magnet.

The lens holder may include an OIS magnet accommodation portion provided on a lower portion of the lens holder, and the OIS magnet may be disposed on the OIS magnet accommodation portion, and the housing may include an OIS coil mounting portion provided on an upper portion of the housing, and the OIS coil may be disposed on the OIS coil mounting portion.

The camera module may include a first rollable member disposed between one side of the housing and one side of the AF holder.

The housing may include a first guide groove that partially accommodates the first rollable member, and the AF holder may include a second guide groove that faces the first guide groove and partially accommodates the first rollable member.

The camera module may further include a second rollable member disposed between an upper surface of the housing and a lower surface of the lens holder.

The housing may include a support groove that supports the second rollable member.

In a general aspect, a camera module includes a lens barrel configured to accommodate at least one lens; an image sensor module comprising a circuit board on which an image sensor configured to convert light incident through the at least one lens into an electrical signal is disposed; a housing disposed above the image sensor module; an auto-focus (AF) holder disposed in an inner opening of the housing, and coupled to the circuit board; a lens holder disposed above the housing; an AF drive part disposed between the AF holder and the housing, and configured to move the AF holder; and an optical image stabilization (OIS) drive part disposed between the housing and the lens holder, and configured to move the lens holder.

The AF drive part may include an AF magnet disposed at one side of the AF holder, and an AF coil disposed at one side of the housing opposite to the AF magnet.

The AF holder may include a frame portion that is fixed to the circuit board and the frame portion has an opening therein, a protruding portion that protrudes upward from one side edge of the frame portion, and an AF magnet accommodation portion, provided at an outer side of the frame portion, and configured to accommodate the AF magnet, wherein the housing may include an AF coil mounting portion that protrudes upward from one side edge of the housing, and the AF coil mounting portion has an opening in which the AF coil is mounted.

The OIS drive part may include an OIS magnet disposed on a lower portion of the lens holder, and an OIS coil disposed on an upper portion of the housing opposite to the OIS magnet.

The lens holder may include an OIS magnet accommodation portion provided on a lower portion of the lens holder, and the OIS magnet may be disposed on the OIS magnet accommodation portion, and the housing may include an OIS coil mounting portion provided on an upper portion of the housing, and the OIS coil may be disposed on the OIS coil mounting portion.

In a general aspect, a camera module includes a housing; an image sensor disposed on a circuit board; an auto-focus (AF) drive unit coupled to the circuit board, and including an AF holder and an AF drive part; and an optical image stabilization (OIS) drive unit, disposed in the housing, and including a lens holder and an OIS drive part, wherein the AF drive unit is configured to move the image sensor in an optical axis direction, and wherein the OIS drive unit is configured to move the lens holder in directions perpendicular to the optical axis direction.

The AF drive unit may include an AF magnet and an AF coil which face each other in a direction perpendicular to the optical axis direction.

The OIS drive part may include OIS magnets and OIS coils that face each other in the optical axis direction.

Other features and aspects will be apparent from the following detailed description, the drawings, and the claims.

### BRIEF DESCRIPTION OF DRAWINGS

FIG. 1 illustrates a perspective view of an external appearance of an example camera module, in accordance with one or more embodiments.

FIG. 2 illustrates an exploded perspective view of the example camera module, in accordance with one or more embodiments.

FIG. 3 illustrates a partial cross-sectional view taken along line V-V′ in FIG. 1.

FIG. 4 illustrates a perspective view of a housing of the example camera module illustrated in FIG. 1.

FIG. 5 illustrates a perspective view of an AF holder of the example camera module illustrated in FIG. 1.

FIG. 6 illustrates a perspective view of a lens holder of the example camera module illustrated in FIG. 1.

FIG. 7 illustrates a perspective view of an AF drive unit of the example camera module illustrated in FIG. 1.

FIG. 8 illustrates an exploded perspective view of the AF drive unit in FIG. 7.

FIG. 9 illustrates a perspective view of an OIS drive unit of the example camera module illustrated in FIG. 1.

FIG. 10 illustrates an exploded perspective view of the OIS drive unit in FIG. 9.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

In addition, throughout the specification, the phrase “in a plan view” means when an object is viewed from above, and the phrase “in a cross-sectional view” means when a cross section made by vertically cutting an object is viewed from a lateral side.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a camera module that reduces the burden caused by an increase in weight of a lens by implementing an autofocus operation by moving an image sensor and implementing an optical image stabilization operation by moving the lens.

In one or more examples, in the camera module according to an example, the AF drive unit and the OIS drive unit are separated, which may reduce the sensing crosstalk between the AF drive unit and the OIS drive unit.

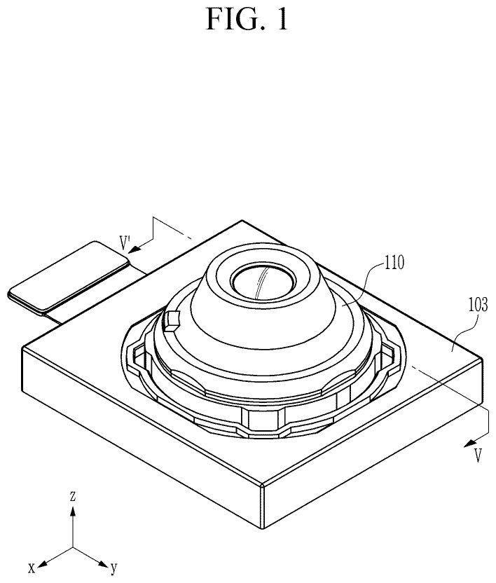

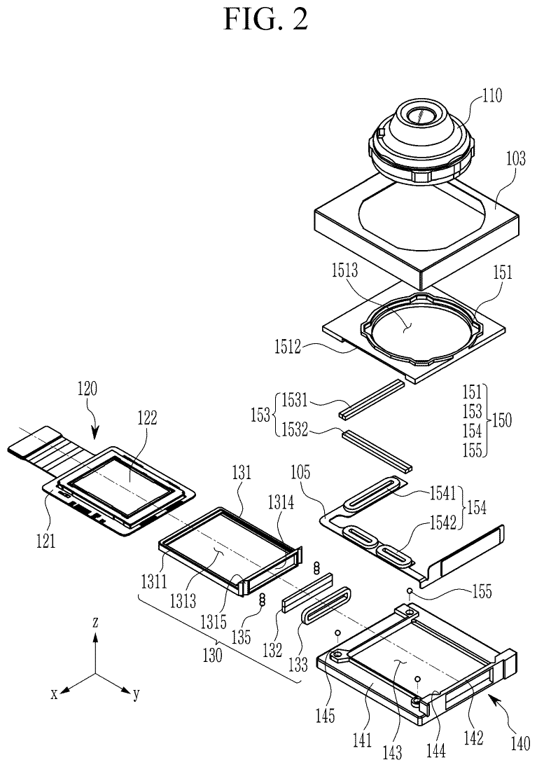

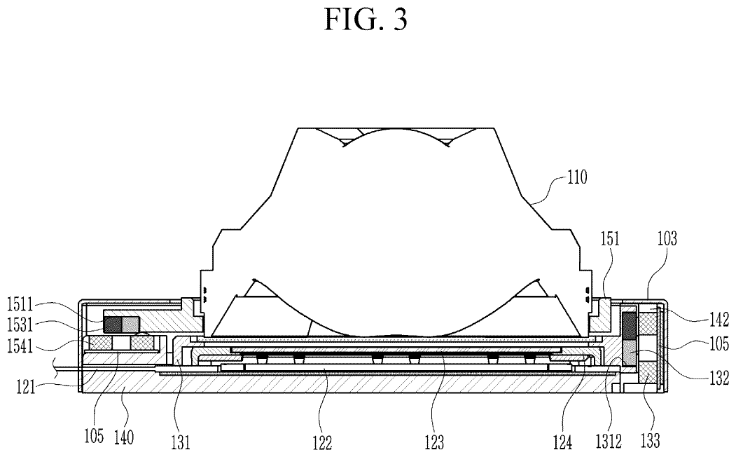

FIG. 1 illustrates a perspective view of an external appearance of an example camera module, in accordance with one or more embodiments, FIG. 2 illustrates an exploded perspective view of the example camera module, in accordance with one or more embodiments, and FIG. 3 is a partial cross-sectional view taken along line V-V′ in FIG. 1.

With reference to FIGS. 1 to 3, an example camera module 100, in accordance with one or more embodiments, includes a lens barrel 110, an image sensor module 120, an AF drive unit 130, an OIS drive unit 150, a housing 140, and a cover 103.

The lens barrel 110 may have a hollow cylindrical shape so as to accommodate therein a plurality of lenses used to capture an image of a subject, and the plurality of lenses may be mounted along an optical axis in the lens barrel 110. A desired number of lenses are disposed in accordance with the implementation of the lens barrel 110. The respective lenses may have the same or different optical characteristics such as refractive indexes.

The optical axis may be set as a central axis of the lens accommodated in the lens barrel 110. An optical axis direction means a direction parallel to the central axis. In the drawings, the optical axis is set as a z-axis, and an x-axis and a y-axis are preset as directions perpendicular to the optical axis. In this example, the x-axis and the y-axis are perpendicular to each other, and an x-y plane defined by the x-axis and the y-axis is a plane perpendicular to the optical axis.

The image sensor module 120 includes a circuit board 121 and an image sensor 122. The circuit board 121 may be electrically connected to a main substrate (not illustrated) and may include, as only examples, a circuit board, such as a rigid circuit board, a flexible circuit board, or a rigid flexible circuit board, having wiring patterns capable of being electrically connected. The circuit board 121 may have the image sensor 122 mounted on one surface and may include connection pads to connect the image sensor 122.

The image sensor module 120 may further include an optical filter 123. The optical filter 123 may be seated in a sub-housing 124, and may prevent light beams, which have a particular frequency band among the light beams introduced into the lens barrel 110, from entering the image sensor 122. For example, the optical filter 123 may include an infrared ray cut-off filter (IR cut-off filter), as only an example.

The image sensor 122 may be an element configured to convert the light, which is introduced through the lens of the lens barrel 110, into an electrical signal. The image sensor 122 may be any one of a charge-coupled device (CCD) and a complementary metal oxide semiconductor (CMOS). However, the one or more examples are not limited thereto.

The image sensor 122 may be positioned below the lens barrel 110 based on the optical axis direction of the lens, and may be connected to the connection pad of the circuit board 121 by a wire. The connection between the image sensor 122 and the circuit board 121 is not limited thereto. It is apparent that the connection may be variously modified to connect the electronic components mounted on the circuit board 121. The electrical signal converted by the image sensor 122 is outputted as an image through a display unit of the electronic device.

The AF drive unit 130 may be disposed in the housing 140, and may include an AF holder 131 and an AF drive part. The AF drive unit 130 may be coupled to the circuit board 121, on which the image sensor 122 is disposed, and may move the image sensor 122 in the optical axis direction. The AF drive unit 130 may adjust a focal point by moving the image sensor module 120 in the optical axis direction (z-axis direction in the drawings).

The AF holder 131 may be disposed in an inner opening 143 of the housing 140 and has an opening 1313 formed through a center of the AF holder 131 in the optical axis direction. The AF holder 131 may guide a movement of the image sensor 122. The light introduced through the lens barrel 110 may pass through the opening 1313 of the AF holder 131 and reach the image sensor 122.

The AF drive part includes an AF magnet 132 and an AF coil 133. The AF magnet 132 and the AF coil 133 may generate driving power to move the image sensor module 120 in the optical axis direction (the z-axis direction in the drawings). That is, when power is applied to the AF coil 133, the AF holder 131 may be moved in the optical axis direction by an electromagnetic force between the AF magnet 132 and the AF coil 133, such that the image sensor module 120 coupled to the AF holder 131 may be moved in the optical axis direction.

In an example, the AF magnet 132 may be disposed at one side of the AF holder 131, and the AF coil 133 may be disposed at one side of the housing 140 based on a substrate 105 so as to be opposite to the AF magnet 132 in a direction perpendicular to the optical axis. In this example, the AF magnet 132 is a movable member that is mounted on the AF holder 131, and is configured to move together with the AF holder 131 in the optical axis direction, and the AF coil 133 is a stationary member that is fixed to the housing 140. However, the one or more examples are not limited thereto. In an example, the positions of the AF magnet 132 and the AF coil 133 may be changed.

First rollable members 135 are disposed between the AF holder 131 and the housing 140 to reduce friction between the AF holder 131 and the housing 140 when the AF holder 131 is moved. The first rollable members 135 may each have a ball shape, and may be disposed at two opposite sides of the AF holder 131 based on a center of one side of the AF holder 131. The first rollable members 135 may have different numbers of balls at each side of the AF holder 131. In a non-limiting example, there may be three balls at the left side of the AF holder 131 and four balls at the right side of the AF holder 131.

The OIS drive unit 150 is used to prevent an image from being blurred or a video from swaying because of factors such as a user's hand shaking during a process of capturing an image or shooting a video. That is, when swaying occurs because of the user's hand shaking or the like at the time of capturing an image, the OIS drive unit 150 compensates for swaying by applying a relative displacement, which corresponds to the swaying, to the lens barrel 110. For example, the OIS drive unit 150 may correct the swaying by moving the lens barrel 110 in first and second directions (x-axis and y-axis directions) perpendicular to the optical axis direction.

The OIS drive unit 150 may be disposed in the housing 140 and include a lens holder 151 and an OIS drive part. The OIS drive unit 150 may be coupled to the lens barrel 110 configured to accommodate the lens, and the OIS drive unit 150 may move the lens barrel 110 in the direction perpendicular to the optical axis.

The lens holder 151 is disposed above the housing 140 and aligned in the optical axis direction, and the lens holder 151 may move the lens barrel 110. The lens holder 151 has a center opening 1513 into which the lens barrel 110 may be inserted. The lens barrel 151 is fixedly coupled to the lens holder 151 through the center opening 1513. For example, the lens holder 151 may have a frame shape having four edges.

The OIS drive part includes OIS magnets 153 and OIS coils 154. The OIS magnets 153 and the OIS coils 154 generate driving power to move the lens barrel 110 in first and second directions (x-axis and y-axis directions in the drawings) perpendicular to the optical axis. Specifically, a first OIS magnet 1531 and a first OIS coil 1541 may generate driving power in the first direction (the x-axis direction in the drawings), and a second OIS magnet 1532 and a second OIS coil 1542 may generate driving power in the second direction (the y-axis direction in the drawings).

In an example, the OIS magnets 153 may be provided below the lens holder 151, and may be disposed in a direction perpendicular to the optical axis, and the OIS coils 154 may be disposed above the housing 140 based on the substrate 105 so as to be opposite to the OIS magnets 153 in the optical axis direction. In this example, the OIS magnet 153 may be a movable member that is mounted on the lens holder 151, and may be configured to move together with the lens holder 151 in the direction perpendicular to the optical axis, and the OIS coil 154 may be a stationary member that is fixed to the housing 140. However, the one or more examples are not limited thereto. The positions of the OIS magnet 153 and the OIS coil 154 may be changed.

Second rollable members 155 are disposed between the lens holder 151 and the housing 140 to reduce friction between the lens holder 151 and the housing 140 when the lens holder 151 is moved. The second rollable members 155 may also maintain an interval between the lens holder 151 and the housing 140. The second rollable members 155 may have a ball shape, and may be disposed between edges adjacent to the lens holder 151. The second rollable member 155 may be disposed on at least one of four vertex portions of the lens holder 151. In this example, support grooves 145 may be formed in the housing 140, and are configured to partially accommodate the second rollable members 155, and support the second rollable members 155.

The housing 140 is disposed above the image sensor module 120, and has an inner opening 143. The AF holder 131 may be disposed in the opening 143 of the housing 140, and the light entering the lens through the opening 143 may reach the image sensor 122.

The housing 140 may include OIS coil mounting portions 141 provided on an upper surface thereof, and an AF coil mounting portion 142 provided at one side thereof. The OIS coil 154 and the AF coil 133 may be respectively disposed on the OIS coil mounting portion 141 and the AF coil mounting portion 142 based on the substrate 105. In this example, the substrate 105 may be coupled to the housing 140, and in an example, may be a circuit board, such as a flexible printed circuit board and a rigid flexible printed circuit board, having wiring patterns, as only examples.

The cover 103 may be coupled to the housing 140 to cover the housing 140. The cover 103 may have a frame shape opened at a lower side thereof and having four edges. The cover 103 protects internal configuration components in the camera module 100. The cover 103 may be formed as a board made of a metallic material, as an example. The cover 103 may be made of a material, such as stainless steel, having a low corrosion rate. Additionally, the cover 103 may block electromagnetic waves. For example, the cover 103 may block electromagnetic waves to prevent electromagnetic waves generated in the camera module 100 from affecting other electronic components in the electronic device, or to prevent electric currents introduced from the outside of the camera module 100 from affecting the inside of the camera module 100. The cover 103 may be grounded to the circuit board 121, and may block electromagnetic waves existing inside and outside the camera module 100.

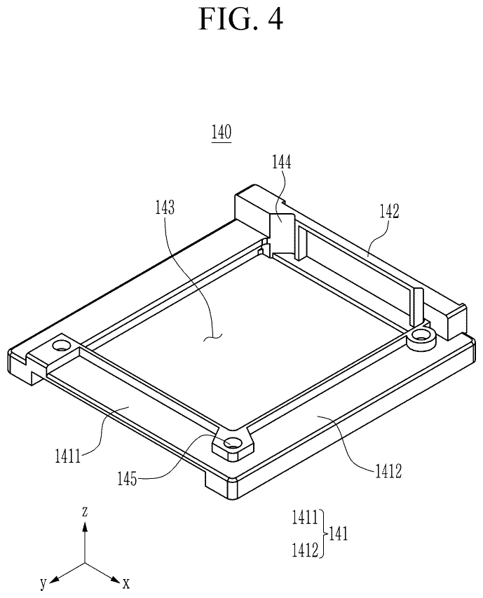

Hereinafter, some configurations of the camera module 100 according to the present embodiment will be described more specifically with reference to FIGS. 4 to 6.

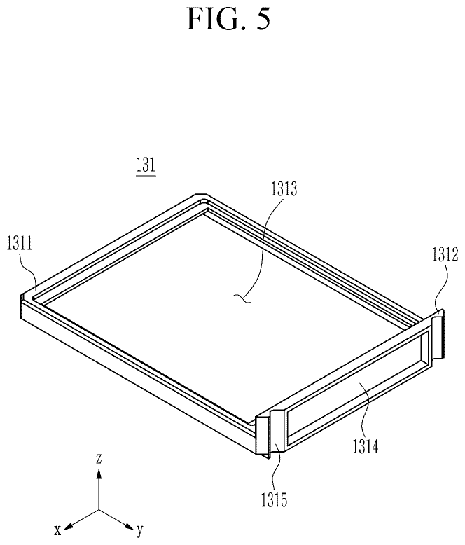

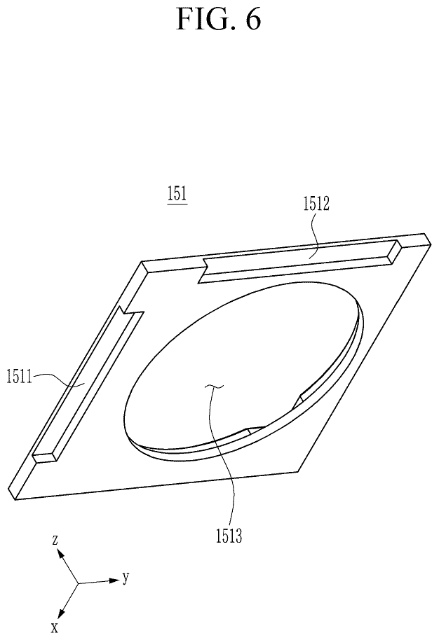

FIG. 4 is a perspective view illustrating the housing 140 of the camera module illustrated in FIG. 1, FIG. 5 is a perspective view illustrating the AF holder 131 of the camera module illustrated in FIG. 1, and FIG. 6 is a perspective view illustrating the lens holder 151 of the camera module illustrated in FIG. 1.

With reference to FIG. 4, the housing 140 is disposed above the image sensor module 120, and serves as a frame on which the AF drive unit 130 and the OIS drive unit 150 are disposed. That is, the AF holder 131, the AF drive part, and the OIS drive part may be disposed in the housing 140. The housing 140 may have a structure with a frame shape having the opening 143 therein. In an example, the housing 140 may have a frame structure with a quadrangular shape, and the opening 143 may also have a quadrangular shape.

The housing 140 may include the OIS coil mounting portions 141 (1411, 1412) provided on the upper surface thereof, and the AF coil mounting portion 142 provided at one side thereof. In an example, the OIS coil mounting portions 141 (1411, 1412) may be formed in the first and second directions (x-axis and y-axis directions in the drawings) so as to correspond to the edges adjacent to the opening 143. A first OIS coil mounting portion 1411 may be formed in the first direction (x-axis in the drawings), and a second OIS coil mounting portion 1412 may be formed in the second direction (y-axis in the drawings).

The AF coil mounting portion 142 may have a shape protruding upward from one side edge of the upper surface of the housing 140 at which the OIS coil mounting portion 141 is not disposed. The AF coil mounting portion 142 may have an opening so that the AF coil 133 is mounted on the AF coil mounting portion 142.

The OIS coil 154 and the AF coil 133 may be respectively mounted on the OIS coil mounting portion 141 and the AF coil mounting portion 142 based on the substrate 105. In this example, the substrate 105 may be a circuit board which has wiring patterns disposed on the OIS coil mounting portion 141 and the AF coil mounting portion 142. In an example, the substrate 105 may have one surface having a shape corresponding to the OIS coil mounting portion 141, and may have a lateral surface that is curved upward from one surface so as to be disposed on the AF coil mounting portion 142. In an example, one surface of the substrate 105 may cover the OIS coil mounting portion 141, and the lateral surface of the substrate 105 may cover the AF coil mounting portion 142 from the outside.

First guide grooves 144 may be provided at one side of a peripheral portion of the AF coil mounting portion 142, and may guide optical axis direction movements of the first rollable members 135 disposed to reduce friction between the AF holder 131 and the housing 140 when the AF holder 131 is moved. The first guide grooves 144 may be disposed at two opposite sides of the opening of the AF coil mounting portion 142, and may have concave shapes to partially accommodate the first rollable members 135. The first guide grooves 144 may be formed as a groove having a ‘V’-shaped cross-section in order to minimize contact with the first rollable members 135. Alternatively, the first guide groove 144 may define a ‘⊏’-shaped surface or a curved surface.

The support grooves 145 may be provided in the upper surface of the housing 140, and may support the second rollable members 155 disposed to reduce friction between the lens holder 151 and the housing 140 when the lens holder 151 is moved. The support grooves 145 may partially accommodate the second rollable members 155, and may have a concave groove shape to restrict a motion of the second rollable members 155. The support grooves 145 may be disposed on at least one of the four vertex portions of the housing 140.

With reference to FIG. 5, the AF holder 131 may be disposed above the image sensor module 120, coupled to the circuit board 121, and may be disposed in the inner opening 143 of the housing 140. The AF holder 131 may have a structure with a frame shape having the opening 1313 therein. In an example, the AF holder 131 may have a frame structure with a quadrangular shape, and the opening 1313 may also have a quadrangular shape.

The AF holder 131 may include a frame portion 1311 formed around the opening 1313 and having a frame shape, and a protruding portion 1312 that protrudes upward from one side edge of the frame portion 1311. The protruding portion 1312 may include an AF magnet accommodation portion 1314 that is provided at an outer side thereof so that the AF magnet 132 is disposed on the AF magnet accommodation portion 1314, and second guide grooves 1315 configured to partially accommodate the first rollable members 135.

The AF magnet accommodation portion 1314 may have a groove shape corresponding in shape and size of the AF magnet 132. The second guide groove 1315 may have a concave shape at one side of a peripheral portion of the AF magnet accommodation portion 1314.

The second guide groove 1315 may be disposed to face the first guide groove 144 of the housing 140, and the first rollable members 135 may be disposed in a space between the second guide groove 1315 and the first guide groove 144. The second guide groove 1315 may be formed as a groove having a ‘V’-shaped cross-section in order to minimize contact with the first rollable member 135. Alternatively, the second guide groove 1315 may define a ‘⊏’-shaped surface or a curved surface.

With reference to FIG. 6, the lens holder 151 may be disposed above the housing 140, and may be aligned in the optical axis direction. In an example, the lens holder 151 may have a frame shape having four edges. The lens holder 151 may include the center opening 1513 into which the lens barrel 110 is inserted, and OIS magnet accommodation portions 1511 and 1512 formed on a lower portion thereof. The lens barrel 110 may be fixed by being coupled to the lens holder 151 through the center opening 1513, and the lens holder 151 may guide the movements of the lens barrel 110 in the first and second directions (x-axis and y-axis directions in the drawings) perpendicular to the optical axis.

The OIS magnet accommodation portions 1511 and 1512 may be formed at adjacent edges of the lens holder 151, and may include a first OIS magnet accommodation portion 1511 formed in the first direction (the x-axis in the drawings) and formed at the edge portion adjacent to the lens holder 151, and a second OIS magnet accommodation portion 1512 formed in the second direction (the y-axis direction in the drawings). The first OIS magnet accommodation portion 1511 may accommodate the first OIS magnet 1531, and the second OIS magnet accommodation portion 1512 may accommodate the second OIS magnet 1532.

The OIS magnet accommodation portions 1511 and 1512 may be formed on a lower surface of the lens holder 151, and may be formed to be opposite to the OIS coil mounting portion 141 of the housing 140 in the optical axis direction.

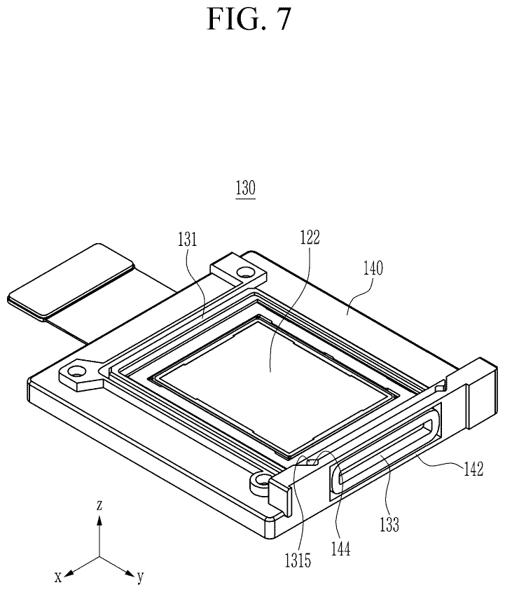

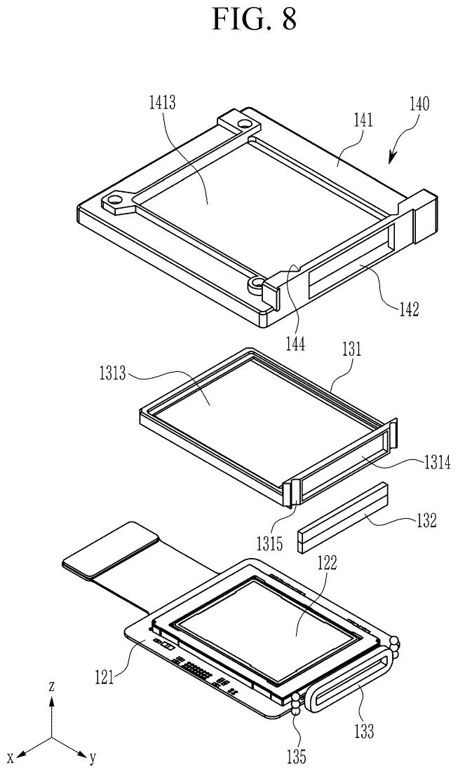

Hereinafter, the AF drive unit of the camera module 100, in accordance with one or more embodiments, will be described more specifically with reference to FIGS. 7 and 8.

FIG. 7 is a perspective view illustrating the AF drive unit of the camera module illustrated in FIG. 1, and FIG. 8 is an exploded perspective view schematically illustrating the AF drive unit in FIG. 7.

With reference to FIGS. 7 and 8, the AF drive unit 130 may be coupled to the circuit board 121, on which the image sensor 122 is disposed, and adjust a focal point by moving the image sensor 122 in the optical axis direction (z-axis direction in the drawings).

The AF drive unit 130 may include the AF holder 131 and the AF drive part. The AF holder 131 is disposed in the inner opening 143 of the housing 140, and has the opening 1313 formed through the center of the AF holder 131 in the optical axis direction. The AF holder 131 is coupled to the circuit board 121, on which the image sensor 122 is disposed, and may guide the movement of the image sensor 122.

The AF drive part may be configured to move the AF holder 131, and may include the AF magnet 132 and the AF coil 133. The AF magnet 132 and the AF coil 133 may be disposed to be opposite to each other in a direction perpendicular to the optical axis. The AF magnet 132 and the AF coil 133 may generate driving power to move the AF holder 131 in the optical axis direction (the z-axis direction in the drawings), and may move the image sensor module 120 in the optical axis direction (the z-axis direction in the drawings). That is, when power is applied to the AF coil 133, the image sensor module 120 may be moved in the optical axis direction based on an electromagnetic force between the AF magnet 132 and the AF coil 133.

The AF magnet 132 may be disposed on the AF magnet accommodation portion 1314 of the AF holder 131, and the AF coil 133 may be disposed on the AF coil mounting portion 142 of the housing 140 based on the substrate 105 so as to be opposite to the AF magnet 132 in a direction perpendicular to the optical axis.

The first and second guide grooves 144 and 1315 may be respectively formed in the housing 140 and the AF holder 131, and may partially accommodate the first rollable members 135. The first rollable members 135 may be disposed in the space between the first guide grooves 144 and the second guide grooves 1315, and may guide the movement of the AF holder 131 in the optical axis direction.

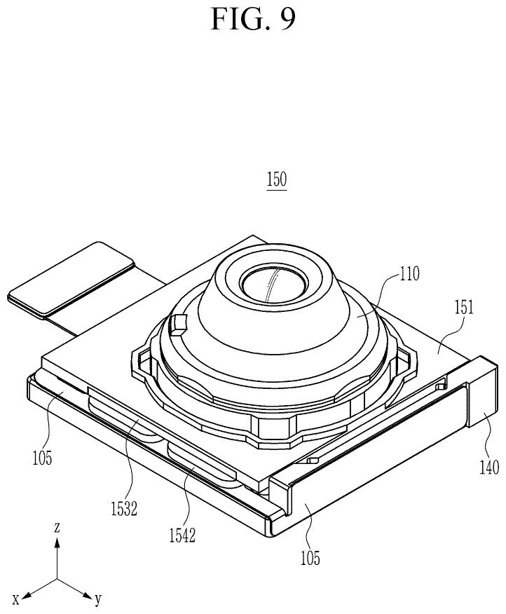

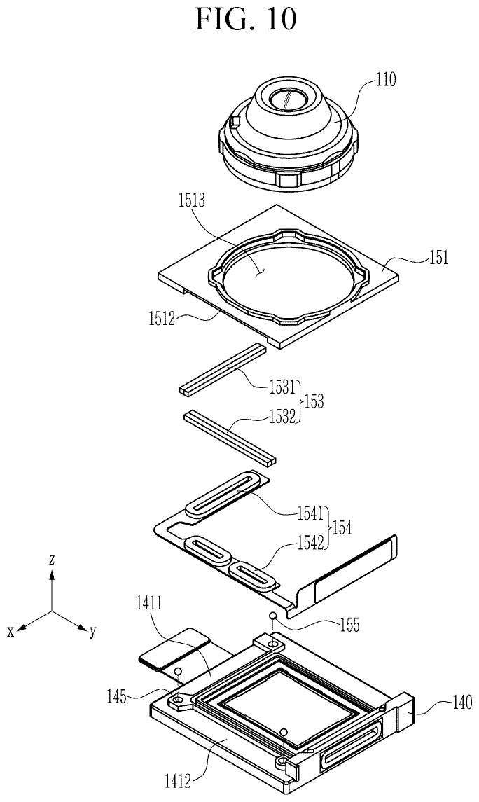

Hereinafter, the OIS drive unit of the camera module 100, in accordance with one or more embodiments, will be described more specifically with reference to FIGS. 9 and 10.

FIG. 9 is a perspective view illustrating the OIS drive unit of the camera module illustrated in FIG. 1, and FIG. 10 is an exploded perspective view schematically illustrating the OIS drive unit in FIG. 9.

With reference to FIGS. 9 and 10, the OIS drive unit 150 may be coupled to the lens barrel 110 which is configured to accommodate the lens, and may correct for hand shaking or swaying by moving the lens barrel 110 in a direction perpendicular to the optical axis.

The OIS drive unit 150 may include the lens holder 151 and the OIS drive part. The lens holder 151 is disposed above the housing 140, and has the center opening 1513 into which the lens barrel 110 may be inserted. The lens holder 151 is coupled to the lens barrel 110 and may guide the movement of the lens barrel 110.

The OIS drive part may be configured to move the lens holder 151, and may include the OIS magnets 153 and the OIS coils 154. The OIS magnets 153 and the OIS coils 154 may be disposed to be opposite to one another in the optical axis direction. The OIS magnets 153 and the OIS coils 154 may generate driving power to move the lens holder 151 in the first and second directions (the x-axis and the y-axis directions in the drawings) perpendicular to the optical axis, and move the lens barrel 110 in the first and second directions (the x-axis and the y-axis directions in the drawings) perpendicular to the optical axis. Specifically, the first OIS magnet 1531 and the first OIS coil 1541 may generate driving power to move the lens holder 151 in the first direction (the x-axis direction in the drawings), and the second OIS magnet 1532 and the second OIS coil 1542 may generate driving power to move the lens holder 151 in the second direction (the y-axis direction in the drawings).

The first OIS magnet 1531 may be disposed on the first OIS magnet accommodation portion 1511 of the lens holder 151, and the first OIS coil 1541 may be disposed on the first OIS coil mounting portion 1411 of the housing 140 based on the substrate 105, such that the first OIS magnet 1531 and the first OIS coil 1541 may generate driving power to move the lens holder 151 and the lens barrel 110 in the first direction (the x-axis direction in the drawings).

The second OIS magnet 1532 may be disposed on the second OIS magnet accommodation portion 1512 of the lens holder 151, and the second OIS coil 1542 may be disposed on the second OIS coil mounting portion 1412 of the housing 140 based on the substrate 105, such that the second OIS magnet 1532 and the second OIS coil 1542 may generate driving power to move the lens holder 151 and the lens barrel 110 in the second direction (the y-axis direction in the drawings).

The second rollable members 155 may be disposed between the housing 140 and the lens holder 151. The second rollable members 155 may be partially accommodated in the support grooves 145 of the housing 140, and may be disposed in rolling contact with the vertex portions of the lens holder 151 that face the support grooves 145, such that the second rollable members 155 may guide the movement of the lens holder 151 in the direction perpendicular to the optical axis.

As described above, according to the one or more examples, the AF drive unit and the OIS drive unit are separated, such that the driving power necessary for the VCM may be reduced, and the sensing crosstalk between the AF drive unit and the OIS drive unit may be reduced.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
an auto-focus (AF) holder coupled to a circuit board on which an image sensor is disposed;
an AF drive part configured to move the AF holder;
a lens holder coupled to a lens barrel configured to accommodate at least one lens; and
an optical image stabilization (OIS) drive part configured to move the lens holder.

2. The camera module of claim 1, further comprising a housing in which the AF holder, the AF drive part, and the OIS drive part are disposed.

3. The camera module of claim 2, wherein the AF holder is disposed in an inner opening of the housing.

4. The camera module of claim 2, wherein the AF drive part comprises an AF magnet disposed at one side of the AF holder, and an AF coil disposed at one side of the housing opposite to the AF magnet.

5. The camera module of claim 4, wherein:
the AF holder comprises an AF magnet accommodation portion provided at one side of the AF holder, and the AF magnet is disposed on the AF magnet accommodation portion, and
the housing comprises an AF coil mounting portion provided at one side of the housing, and the AF coil is disposed on the AF coil mounting portion.

6. The camera module of claim 2, wherein the OIS drive part comprises an OIS magnet disposed on a lower portion of the lens holder, and an OIS coil disposed on an upper portion of the housing opposite to the OIS magnet.

7. The camera module of claim 6, wherein:
the lens holder comprises an OIS magnet accommodation portion provided on a lower portion of the lens holder, and the OIS magnet is disposed on the OIS magnet accommodation portion, and
the housing comprises an OIS coil mounting portion provided on an upper portion of the housing, and the OIS coil is disposed on the OIS coil mounting portion.

8. The camera module of claim 2, further comprising a first rollable member disposed between one side of the housing and one side of the AF holder.

9. The camera module of claim 8, wherein the housing comprises a first guide groove that partially accommodates the first rollable member, and the AF holder comprises a second guide groove that faces the first guide groove and partially accommodates the first rollable member.

10. The camera module of claim 2, further comprising a second rollable member disposed between an upper surface of the housing and a lower surface of the lens holder.

11. The camera module of claim 10, wherein the housing comprises a support groove that supports the second rollable member.

12. A camera module, comprising:
a lens barrel configured to accommodate at least one lens;
an image sensor module comprising a circuit board on which an image sensor configured to convert light incident through the at least one lens into an electrical signal is disposed;
a housing disposed above the image sensor module;
an auto-focus (AF) holder disposed in an inner opening of the housing, and coupled to the circuit board;
a lens holder disposed above the housing;
an AF drive part disposed between the AF holder and the housing, and configured to move the AF holder; and
an optical image stabilization (OIS) drive part disposed between the housing and the lens holder, and configured to move the lens holder.

13. The camera module of claim 12, wherein the AF drive part comprises an AF magnet disposed at one side of the AF holder, and an AF coil disposed at one side of the housing opposite to the AF magnet.

14. The camera module of claim 13,
wherein the AF holder comprises:
a frame portion that is fixed to the circuit board and the frame portion has an opening therein;
a protruding portion that protrudes upward from one side edge of the frame portion; and
an AF magnet accommodation portion, provided at an outer side of the frame portion, and configured to accommodate the AF magnet, and
wherein the housing comprises an AF coil mounting portion that protrudes upward from one side edge of the housing, and the AF coil mounting portion has an opening in which the AF coil is mounted.

15. The camera module of claim 12, wherein the OIS drive part comprises an OIS magnet disposed on a lower portion of the lens holder, and an OIS coil disposed on an upper portion of the housing opposite to the OIS magnet.

16. The camera module of claim 15, wherein:
the lens holder comprises an OIS magnet accommodation portion provided on a lower portion of the lens holder, and the OIS magnet is disposed on the OIS magnet accommodation portion, and
the housing comprises an OIS coil mounting portion provided on an upper portion of the housing, and the OIS coil is disposed on the OIS coil mounting portion.

17. A camera module, comprising:
a housing;
an image sensor disposed on a circuit board;
an auto-focus (AF) drive unit coupled to the circuit board, and including an AF holder and an AF drive part; and
an optical image stabilization (OIS) drive unit, disposed in the housing, and including a lens holder and an OIS drive part,
wherein the AF drive unit is configured to move the image sensor in an optical axis direction, and
wherein the OIS drive unit is configured to move the lens holder in directions perpendicular to the optical axis direction.

18. The camera module of claim 17, wherein the AF drive unit comprises an AF magnet and an AF coil which face each other in a direction perpendicular to the optical axis direction.

19. The camera module of claim 17, wherein the OIS drive part comprises OIS magnets and OIS coils that face each other in the optical axis direction.
